(19) United States
(12) Patent Application Publication
(10) Pub. No.: US 2005/0028414 A1
(43) Pub. Date: Feb. 10, 2005

(54) Vehicle emergency sign

(76) Inventor: Ilsong Rhee, Torrance, CA (US)

Correspondence Address: LEE, HONG, DEGERMAN, KANG & SCHMADEKA, P.C., 801 SOUTH FIQUEROA STREET, 14TH FLOOR, LOS ANGELES, CA, 90017, US

(21) Appl. No.: 10/876,521

(22) Filed: Jun. 25, 2004

(30) Foreign Application Priority Data
Jun. 27, 2003 (KR) 20-2003-0020514

(51) Int. Cl. G09F 21/04

(52) U.S. Cl. 40/591; 40/442

(57) ABSTRACT

The present invention provides a vehicle emergency sign used to alert oncoming traffic of a disabled vehicle comprising a main body, a plurality of light sources coupled to the main body, a controller for controlling the plurality of light sources, attaching means for attaching the main body to a surface of a vehicle and powering means for powering the controller and the plurality of light sources.

### CROSS-REFERENCE TO RELATED APPLICATIONS

Pursuant to 35 U.S.C. § 119(a), this application claims the benefit of earlier filing date and right of priority to Korean Application No. 20-2003-0020514, filed on Jun. 27, 2003, the contents of which are hereby incorporated by reference herein in their entirety.

### BACKGROUND OF THE INVENTION

1. Field of the Invention

The present invention relates to a traffic safety sign, and more particularly, to an emergency sign, which can be used to alert oncoming traffic of a disabled vehicle.

2. Description of the Related Art

In the field of vehicular travel, it is commonly known that vehicles have a tendency to break down at completely random times, often on a major highway. When such an unexpected condition occurs, the driver of the vehicle provides a warning or signal to the other drivers on the road.

One device used to warn approaching traffic of the presence of a stopped vehicle is the free-standing triangle. This device is triangle-shaped and placed on the ground directly behind a vehicle to notify oncoming motorists to proceed with caution. The device is colored with a reflective material to improve visibility. A disadvantage of the free-standing triangle is that it requires heavy mounting stands or bases to prevent it from blowing away in the wind. This renders the device cumbersome to use. Furthermore, the collapsed device may not be stored in an easily accessible location of the vehicle because of its many parts. Thus, the device must be carried in the trunk of the car where it fills up valuable space. Also, the free-standing triangle may not be readily accessible during an emergency because various items placed in the trunk of the car by the car owner may mix with the various parts of the device. This would make utilization of the device laborious and time consuming if the car owner had to first separate personal items from device components before assembly. Moreover, because the device is positioned on the ground, it is not as visible to a driver of an oncoming vehicle as would a sign positioned closer to the driver eye level.

A variation of the free-standing triangle is the use of a triangle capable of being mounted onto the vehicle itself. Thus, it would be positioned closer to the driver eye level. This device is smaller than the free-standing triangle and can be stored in a more accessible location within the automobile. The device uses a reflective exterior or a glaring diode to warn approaching vehicles of possible danger. However, a disadvantage of the smaller triangle is its inefficiency to function as a warning system. Because of its small size, many drivers approaching the stopped vehicle often miss the sign and hit the troubled vehicle from the rear.

Another disadvantage of both the free-standing triangle and the vehicle-mounted triangle is that it merely warns oncoming drivers of possible danger but makes no suggestion as to how to avoid the danger.

Therefore, there is a need for a vehicle emergency sign for alerting oncoming traffic of a disabled vehicle which is highly visible, convenient to use, easily storable an accessible and suggests how to avoid the danger of a stopped vehicle.

### SUMMARY OF THE INVENTION

The present invention is directed to a vehicle emergency sign used to alert oncoming traffic of a disabled vehicle involuntarily stopped on the road due to engine trouble, no fuel, flat tire or other causes. The vehicle emergency sign of the present invention warns approaching vehicles of a disabled vehicle and notifies them to change lanes in order to avoid an accident. The device comprises a plurality of flashing lights arranged in an arrow shape and is capable of being rolled up for convenience of storage. During an emergency, the driver of the troubled vehicle will take the vehicle emergency sign out of the car, unroll it, attach it to the rear side of the vehicle and plug a power jack of the sign into a power outlet, such as a cigarette lighter socket located in the vehicle. Once powered, the lights illuminate. By way of a controller, such as a circuit board housed within the sign, the lights flash according to a predetermined sequence to not only warn oncoming drivers of the stopped vehicle but to also suggest the best way to avoid the vehicle.

The vehicle emergency sign of the present invention can be conveniently stored and carried because it can be folded or rolled into a smaller volume. Further, the sign includes a fastening system which maintains the sign in a folded or rolled state. The sign is also simple to install because of its simple attaching means. No tools or cumbersome equipment is necessary to mount the sign onto a surface of the vehicle. The sign is highly visible because of its size. Preferably, when unfolded, the dimensions of the sign are 110 cm by 50 cm. The sign is also highly visible because it utilizes lights to warn oncoming drivers of danger. The sign can also suggest how to avoid the oncoming danger by way of the arrow-shaped light formation.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

In one aspect of the invention, a vehicle emergency sign comprises a main body, a plurality of light sources coupled to the main body, a controller for controlling the plurality of light sources, attaching means for attaching the main body to a surface of a vehicle and powering means for powering the controller and the plurality of light sources.

In another aspect of the invention, a vehicle emergency sign comprises a main body made of a flexible material, the main body capable of being rolled into a rolled state, a plurality of light sources coupled to the main body, each light source having a bulb, a controller for controlling the plurality of light sources, at least one magnet for attaching the main body to a surface of a vehicle, a power jack for accessing a power outlet to power the controller and the plurality of light sources and a fastening system for maintaining the rolled state of the main body.

In a further aspect of the invention, a main body comprises a plurality of sheets made of a flexible material, the main body capable of being rolled into a rolled state, a plurality of light sources coupled to the main body, each light source having a bulb, a controller for causing the plurality of light sources to illuminate, at least one magnet for attaching the main body to a surface of a vehicle, a power jack for accessing a power outlet to power the controller and the plurality of light sources and a fastening system for maintaining the rolled state of the main body, the fastening system comprising a strap and a strap receiver, the strap being attached to an edge of the main body and the strap receiver being attached to a surface of the main body opposite of where the plurality of light sources is coupled.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a perspective view of a vehicle emergency sign according to an embodiment of the present invention.

FIG. 2 is a side view of a light source coupled to a main body of a vehicle emergency sign according to an embodiment of the present invention.

FIG. 3 is a perspective view of a vehicle emergency sign comprising a fastening system according to an embodiment of the present invention.

FIG. 4 is a perspective view of a vehicle emergency sign rolled into a smaller volume according to an embodiment of the present invention.

FIG. 5a is a front side view of a vehicle emergency sign according to an embodiment of the present invention.

FIG. 5b is a back side view of a vehicle emergency sign according to an embodiment of the present invention.

FIG. 5c is a left side view of a vehicle emergency sign according to an embodiment of the present invention.

FIG. 5d is a right side view of a vehicle emergency sign according to an embodiment of the present invention.

### DETAILED DESCRIPTION OF THE PREFERRED EMBODIMENTS

The present invention relates to a vehicle emergency sign used to alert oncoming traffic of a disabled vehicle. With reference to the drawings, the vehicle emergency sign embodying the principles and concepts of the present invention will now be described.

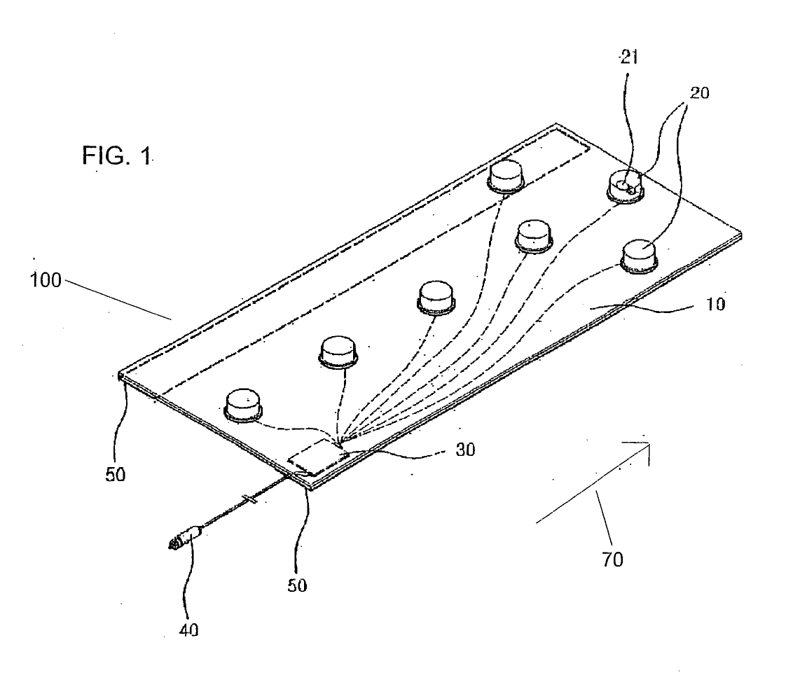

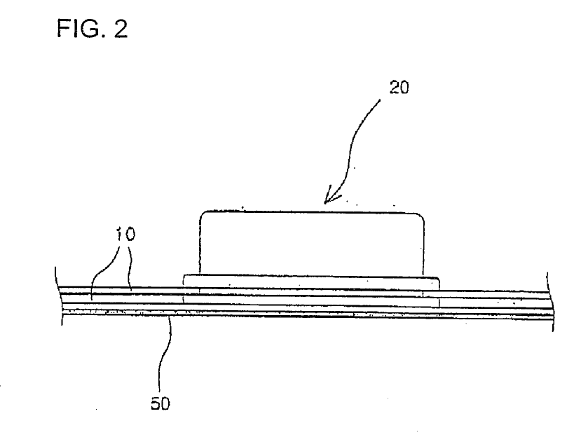

Referring to FIGS. 1 and 2, a vehicle emergency sign 100 according to an embodiment of the present invention comprises a main body 10, a plurality of light sources 20 coupled to the main body 10, a controller 30 for controlling the plurality of light sources 20, attaching means 50 for attaching the main body 50 to a surface of a vehicle and powering means 40 for powering the controller 30 and the plurality of light sources 20.

Preferably, the main body 10 comprises a pair of sheets made of a material such as rubber, canvas, synthetic leather or other flexible material. The main body 10 includes a space in between the sheets for housing components of the vehicle emergency sign. The plurality of light sources 20 are mounted onto a surface of the main body 10. Each light source comprises a bulb 21. When powered, the bulbs illuminate to warn oncoming drivers of a stopped vehicle. It is contemplated that the maximum output of the bulbs will enable a driver of an approaching vehicle to spot the disabled vehicle from over 100 meters away. Preferably, seven to nine light sources are placed on the main body 10 in an arrow shape; however, it is contemplated that any number of light sources arranged in various different shapes may be utilized. The controller 30 is housed within the plurality of sheets and is connected to each light source 20 by a wire respectively. Like the controller 30, the wires are housed within the plurality of sheets. Each wire runs from the controller 30 through the main body 10 and connects to a part of a respective light source 20 accessible from within the main body 10.

The attaching means 50 is coupled onto a surface of the main body 10 opposite of where the plurality of light sources 20 are mounted. The attaching means 50 may be permanently mounted to the main body 10 using adhesive means such as permanent glue or mechanical means such as screws or other mechanical attaching devices. Alternatively, the attaching means 50 may also be removably coupled to the main body 10 using a non-permanent coupling means such as a Velcro fastener. Preferably, the attaching means 50 comprises a pair of magnetic strips mounted along a perimeter of the main body 10 and serve to adhere to a metallic surface of a vehicle via magnetic attraction. Use of a magnet to attach the vehicle emergency sign to the disabled vehicle is advantageous because of its ease of use and simplicity. A user merely has to place the attaching means 50 near the surface of the car where the sign is to be posted. Once close enough to the target area, the magnet will self-mount itself onto the vehicle. Thus, the need for cumbersome tools or other mechanical parts necessary for mounting the sign has been eliminated. While using magnets is preferred, it is contemplated that other simple and easy to use mounting devices, such as tape, fasteners or suction cups may also be utilized to attach the vehicle emergency sign to the disabled vehicle.

Preferably, the powering means 40 comprises a power jack capable of accessing or plugging in to a power outlet located within the vehicle. The power outlet, for example, may be a cigarette lighter socket. The power jack directly connects to the controller 40 via a wire. In operation, when the power jack is plugged into the power outlet, the power jack will supply power from the power outlet to the plurality of light sources through the controller 40. Once power is supplied, the controller 40 is able to control the light sources 20. Preferably, the controller 40 is a circuit board capable of causing the light sources to illuminate in a number of ways. Specifically, the controller 40 may illuminate the light sources continuously wherein all the bulbs 21 are lit the entire time the vehicle emergency sign is powered. Further, the controller 40 may cause the light sources to flash wherein all the bulbs 21 illuminate on and off according to a predetermined frequency. The controller is also capable of illuminating the light sources 20 according to a predetermined sequence such that each of the bulbs 21 individually illuminate on an off according to a serial pattern. Preferably, the bulbs 21 are colored amber; however, the vehicle emergency sign of the present invention may utilize any color of bulb.

Referring again to FIG. 1, the serial pattern of the preferred embodiment will be described. Generally, once powered, the controller 40 causes the light sources 20 to illuminate on and off in the direction of arrow 70. The controller achieves this by first illuminating the light source nearest the power jack and then turning it off. Once off, the controller then illuminates the light source second nearest to the power jack and then turns it off. The controller continues down the line until the light source farthest from the power jack is illuminated and then turned off. After the final light source is turned off, the cycle is repeated such that the light sources serially flash in the direction of arrow 70. Such a design not only warns oncoming cars of a stopped vehicle ahead, but also suggests to a driver the best way to avoid the disabled vehicle by indicating which way the driver should turn according to the direction the arrow is pointed in. Additionally, because of the versatility of the attaching means 50, the sign of the present invention can be mounted onto a surface of a vehicle in several directions. Thus, the light sources can point in any desired direction including up, down, left or right.

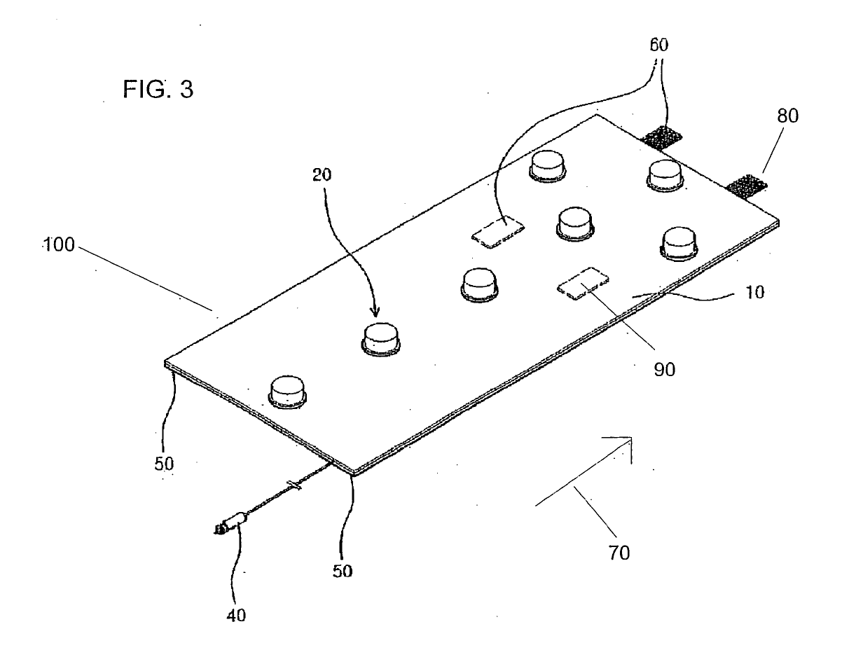

Referring to FIG. 3, the vehicle emergency sign according to another embodiment of the present invention includes a fastening system 60 for allowing the vehicle emergency sign to maintain a folded or rolled state. The fastening system 60 comprises a strap 80 fixed to an edge of the main body 10 and a strap receiver 90 fixed to a surface of the main body 10 opposite of where the light sources 20 are mounted. The strap 80 and the strap receiver 90 securedly attach to one another and may employ any one of many attaching devices commonly known to securedly couple two objects together. Such devices include buttons, hooks, magnets, Velcro, etc. The attachment of the strap 80 and the strap receiver 90 is secure enough to keep the vehicle emergency sign from unfolding or unrolling once the sign has been folded or rolled.

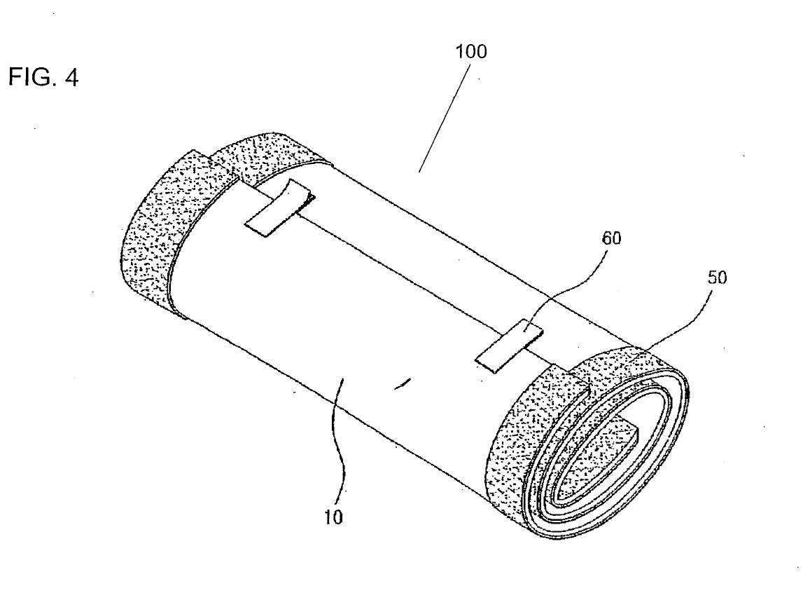

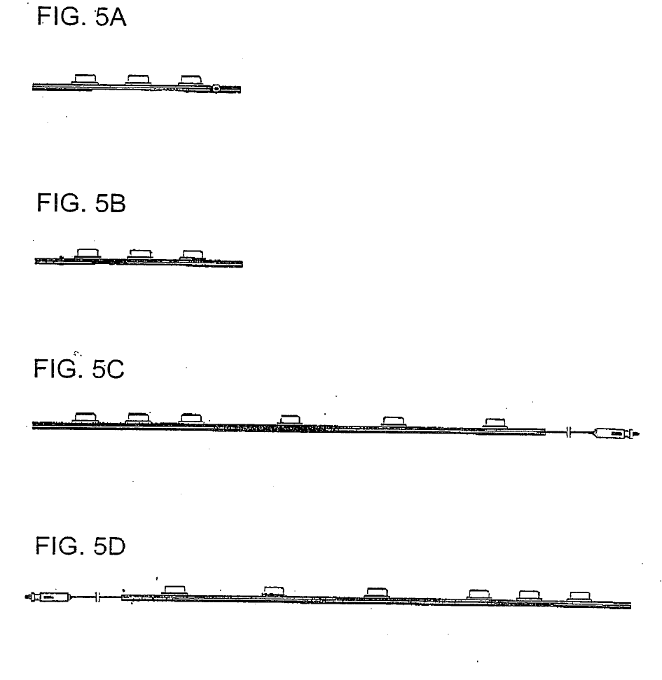

As shown in FIG. 3, when the vehicle emergency sign is folded or rolled in the direction of arrow 70, the strap receiver 90 coupled to the surface of the main body 10 opposite the light sources 20, will near the vicinity of the strap 80. When the strap receiver 90 is near enough to the strap 80, the user can affix the strap 80 onto the strap receiver 90 and create a secure attachment. As shown in FIG. 4, the fastening system 60 maintains the main body 10 in a folded or rolled state. Such makes the vehicle emergency sign of the present invention easy to carry and easily storable. The sign may be stored conveniently in the passenger compartment of the vehicle or in the trunk without filling up valuable space.

During an emergency, the driver of the troubled vehicle will take the vehicle emergency sign out of the car, unroll it and attach it to the rear side of the vehicle using the attaching means 50. No tools or other cumbersome equipment is necessary for attachment. Once attached, the powering means 40 will be plugged into a power outlet located within the vehicle to supply power to the controller 40 and the plurality of light sources 20. Once powered, the controller 40 causes the light sources 20 to illuminate according to a predetermined serial pattern. Because of the sign's size and the use of light sources 20, the sign will be highly visible to oncoming drivers and sufficiently warn them of a disabled vehicle ahead. Because the light sources 20 are formed on the main body 10 in an arrow shape, the vehicle emergency sign can also suggest to the oncoming driver the best way to avoid the stopped vehicle according to the direction the arrow is pointed in. The vehicle emergency sign is made of a flexible material. Thus, it can be folded or rolled into a smaller volume for convenience of storage. The sign also includes a fastening system 60 comprising a strap 80 and a strap receiver 90 designed to securedly attach to each other and are each placed at locations on the main body 10 such that the strap 80 and the strap receiver 90 are able to maintain the vehicle emergency sign in a folded or rolled state.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

1. A vehicle emergency sign, comprising:
a main body;
a plurality of light sources coupled to the main body;
a controller for controlling the plurality of light sources;
attaching means for attaching the main body to a surface of a vehicle; and
powering means for powering the controller and the plurality of light sources.

2. The vehicle emergency sign of claim 1 wherein the main body comprises a plurality of sheets, the sheets being made of a flexible material.

3. The vehicle emergency sign of claim 2 wherein each light source is connected to the controller by a wire, each wire being housed within the plurality of sheets.

4. The vehicle emergency sign of claim 2 wherein the controller is housed within the plurality of sheets.

5. The vehicle emergency sign of claim 1 wherein the plurality of light sources are arranged in an arrow shape on the main body.

6. The vehicle emergency sign of claim 1 wherein the controller causes the plurality of light sources to illuminate.

7. The vehicle emergency sign of claim 6 wherein the controller causes the plurality of light sources to illuminate according to a serial pattern.

8. The vehicle emergency sign of claim 1 wherein the powering means comprises a power jack capable of accessing a power outlet of the vehicle.

9. The vehicle emergency sign of claim 8 wherein the powering means includes a wire having a first end connected to the power jack and a second end connected to the controller.

10. The vehicle emergency sign of claim 1 wherein the attaching means comprises a magnet.

11. The vehicle emergency sign of claim 1 wherein the main body is capable of being rolled into a rolled state.

12. The vehicle emergency sign of claim 11 further comprising a fastening system for maintaining the rolled state.

13. The vehicle emergency sign of claim 12 wherein the fastening system comprises a strap and a strap receiver.

14. The vehicle emergency sign of claim 13 wherein the strap is attached to an edge of the main body and the strap receiver is attached to a surface of the main body opposite of where the plurality of light sources is coupled.

15. A vehicle emergency sign, comprising:
a main body made of a flexible material, the main body capable of being rolled into a rolled state;
a plurality of light sources coupled to the main body, each light source having a bulb;
a controller for controlling the plurality of light sources;
at least one magnet for attaching the main body to a surface of a vehicle;
a power jack for accessing a power outlet to power the controller and the plurality of light sources; and
a fastening system for maintaining the rolled state of the main body.

16. The vehicle emergency sign of claim 15 wherein the main body comprises a plurality of sheets.

17. The vehicle emergency sign of claim 15 wherein the controller causes the plurality of light sources to illuminate.

18. The vehicle emergency sign of claim 17 wherein the controller causes the plurality of light sources to illuminate according to a serial pattern.

19. The vehicle emergency sign of claim 15 wherein the fastening system comprises a strap and a strap receiver, the strap being attached to an edge of the main body and the strap receiver being attached to a surface of the main body opposite of where the plurality of light sources is coupled.

20. A vehicle emergency sign, comprising:
a main body comprising a plurality of sheets made of a flexible material, the main body capable of being rolled into a rolled state;
a plurality of light sources coupled to the main body, each light source having a bulb;
a controller for causing the plurality of light sources to illuminate;
at least one magnet for attaching the main body to a surface of a vehicle;
a power jack for accessing a power outlet to power the controller and the plurality of light sources; and
a fastening system for maintaining the rolled state of the main body, the fastening system comprising a strap and a strap receiver, the strap being attached to an edge of the main body and the strap receiver being attached to a surface of the main body opposite of where the plurality of light sources is coupled.
